(19) United States
(12) Patent Application Publication
(10) Pub. No.: US 2025/0092633 A1
(43) Pub. Date: Mar. 20, 2025

(54) Electric Work Machine Tool Quick Coupler Retention Device

(71) Applicant: Caterpillar Inc., Peoria, IL (US)

(72) Inventor: Shaun D. Currier, Naperville, IL (US)

(73) Assignee: Caterpillar Inc., Peoria, IL (US)

(21) Appl. No.: 18/467,861

(22) Filed: Sep. 15, 2023

(51) Int. Cl. E02F 3/36; F16D 9/02

(52) U.S. Cl. CPC E02F 3/3622; F16D 9/02

(57) ABSTRACT

A device for securing an attachment to a coupler. The device includes: a retention pin defining an elongate direction and configured to be disposed on the coupler, where, to secure the coupler to the attachment, the pin can move in the elongate direction to insert a first end, of the retention pin, into an opening in the attachment; and a thermoactuator including: a chamber associated with the coupler and containing a material that changes volume with temperature, where an end of the chamber is sealed with a piston that is mechanically connected to the retention pin proximate to a second end of the pin, the second end being disposed opposite the first end; and an electric temperature-altering device that, when activated, changes the temperature and volume of the material causing the piston to exert a force on the pin that moves the pin relative to the opening in the attachment.

### BACKGROUND

Machines, for example, wheel loaders, track loaders, excavators, dozers, and the like, are used to accomplish a wide range of tasks, some indoors, some outdoors. Operating environments include construction sites, demolition sites, infrastructure construction and repair sites, warehouses, mining sites, transportation depots and ports, and the like. These tasks may involve the movement of material from one location to another. Depending on the type of material to be moved, different equipment may be required, or at least be advantageous. A wheel loader may move a pallet of lumber using forks and earth using a bucket. Switching from one attachment to another (for example, switching work tools from forks to a bucket) on a machine can require an operator to exit the cab, manually remove the current attachment, re-enter the cab, reposition the machine by the desired attachment, exit the cab, and connect the desired attachment, and return to the cab.

Hydraulics may be used to automatically connect attachments (for example, work tools) to a machine. However, there may be a need to convert to hydraulic power to operate the hydraulics. As a result, energy may be lost and/or there may be additional cost and/or maintenance associated with the conversion to hydraulic power. The device of the present disclosure solves one or more of the problems set forth above and/or other problems in the art.

### BRIEF SUMMARY

One or more aspects of the present invention provides a device for securing an attachment to a coupler. The device may include: a retention pin defining an elongate direction and configured to be disposed on the coupler, wherein, to secure the coupler to the attachment, the retention pin is configured to move in the elongate direction to insert a first end, of the retention pin, into an opening in the attachment; and a thermoactuator including: a chamber associated with the coupler and containing a material that changes volume as a function of temperature, wherein an end of the chamber is sealed with a piston that is mechanically connected to the retention pin proximate to a second end of the retention pin, the second end being disposed opposite the first end; and an electric temperature-altering device that, when activated, changes the temperature and volume of the material causing the piston to exert a first force on the retention pin that moves the retention pin relative to the opening in the attachment.

One or more aspects of the present invention provides a coupler configured to be disposed on a machine and to securely connect an attachment to the machine. The coupler may include a device for securing the attachment to the coupler, the device including: a retention pin comprising an elongate direction and configured to be disposed on the coupler and to move in the elongate direction to insert a first end in the elongate direction into an opening in the attachment, securing the coupler to the attachment; a thermoactuator including: a chamber configured to be fastened to the coupler, containing a material comprising a volume that changes as a function of temperature, and sealed at an end with a piston that is mechanically connected to the retention pin proximate to a second end of the retention pin, the second end being disposed opposite the first end; and an electric temperature-altering device that, while activated, changes the temperature and volume of the material causing the piston to exert a first force on the retention pin that moves the retention pin relative to the opening in the attachment.

One or more aspects of the present invention provides a machine. The machine includes: a means of moving; a coupler configured to be disposed on the machine and including a device to securely connect an attachment to the machine via the coupler, the device including: a retention pin defining an elongate direction and configured to be disposed on the coupler, wherein to secure the coupler to the attachment, the retention pin is configured to move in the elongate direction to insert a first end of the retention pin into an opening in the attachment; and a thermoactuator including: a chamber configured to be fastened to the coupler, containing a material comprising a volume that changes as a function of temperature, and sealed at an end with a piston that is mechanically connected to the retention pin proximate to a second end of the retention pin, the second end being disposed opposite the first end; and an electric temperature-altering device that, while activated, changes the temperature and volume of the material causing the piston to exert a first force on the retention pin that moves the retention pin relative to the opening in the attachment.

### BRIEF DESCRIPTION OF THE DRAWINGS

FIG. 1 depicts a side view of a machine in accordance with one or more aspects of the present disclosure.

FIG. 2 depicts a side view of a coupler and attachment in accordance with one or more aspects of the present disclosure.

FIG. 3 depicts a perspective view of a coupler in accordance with one or more aspects of the present disclosure.

FIG. 4 depicts a perspective view of a material handling arm in accordance with one or more aspects of the present disclosure.

FIG. 5 depicts a side view of a retention pin in accordance with one or more aspects of the present disclosure.

FIG. 6 depicts cross-sectional views of a wax motor when activated and deactivated in accordance with one or more aspects of the present disclosure.

FIG. 7 presents a schematic view of a control system for a thermoactuator in accordance with one or more aspects of the present disclosure.

FIGS. 8A and 8B present a thermoactuator that is collinear and coplanar, respectively, with a retention pin in accordance with one or more aspects of the present disclosure.

FIGS. 9A and 9B depict a cut-away view of a bucket attachment unlocked and locked respectively to a coupler that includes a thermoactuator in accordance with one or more aspects of the present disclosure.

FIGS. 10A and 10B depict a cut-away view of a bucket attachment unlocked and locked respectively to a coupler that includes a thermoactuator and a spring in accordance with one or more aspects of the present disclosure.

FIGS. 11A and 11B depict a cut-away view of a bucket attachment unlocked and locked respectively to a coupler that includes opposing thermoactuators in accordance with one or more aspects of the present disclosure

### DETAILED DESCRIPTION

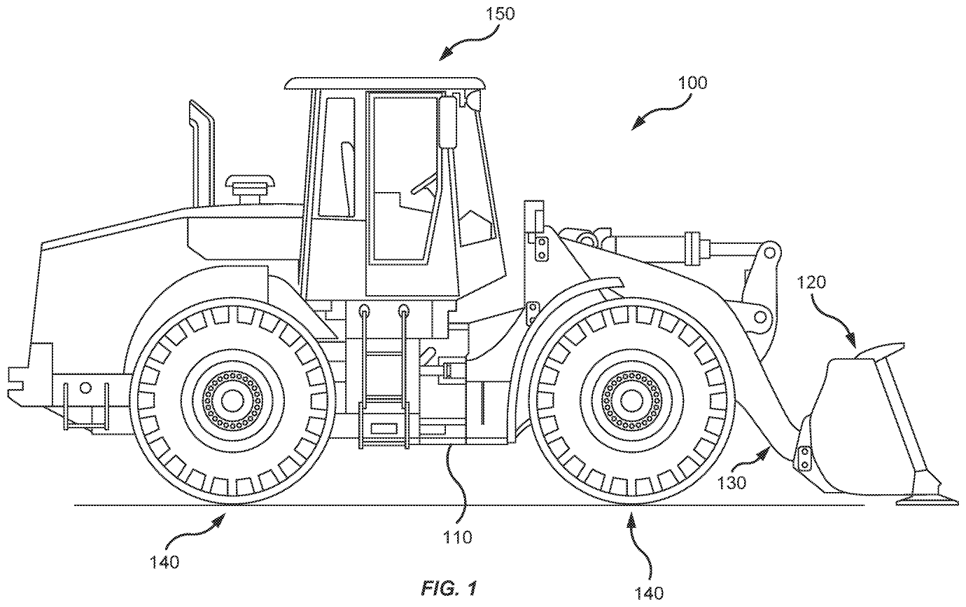

A non-limiting example of a machine 100 is depicted in FIG. 1. In this case, the machine 100 depicted is a wheel loader. The machine 100 includes a chassis 110 and a bucket 120 for loading and unloading material. The bucket 120 is connected to the chassis 110 by a boom 130. In this example, the machine 100 uses wheels 140 for changing work location or moving a load of material from one position to another. A machine 100 may use other means of moving, either separately or in combination. These means may include tracks, legs, and the like. The bucket 120 may be attached to the machine 100 (e.g., to the boom 130) directly or via a coupler, which will be discussed below. An operator can control the machine 100 from the cab 150.

Machines may be powered by electricity, either in part or fully. The electrical power may be provided in a variety of ways. For example, batteries (chemical, thermal, and the like) may store energy in various forms that may be converted into electricity to power a machine. Supercapacitors (or ultracapacitors) may store electrical energy. Flywheels and other mechanical energy storage devices may also be used to provide electrical energy. Internal combustion engines may power electrical generators that may provide electrical energy to motors, batteries, and/or other energy storage devices. In some examples, fuel cells may be a source of electrical energy. Electrical energy may be delivered as direct current (DC) or alternating current (AC) and readily converted from one form to the other using converters or inverters, as appropriate.

Electrical energy may be used in a machine to enable a coupler mounted on the machine to quickly connect with and disconnect from an attachment. Such attachments may include plows (snow plows, angle plows, V-plows, box plows, and the like), snow pushers, spreaders, forks (including log and lumber forks and pipe and pole forks), material handling arms (that is, jibs), grapples, high dumps, buckets, brooms (including pickup brooms and angle brooms), rakes, excavator buckets (which may attach differently than loader buckets), forestry equipment, and the like. In one or more aspects, the attachment may include a work tool that includes at least one member of a group consisting of a plow, a spreader, forks, a material handling arm, a grapple, a high dump, a bucket, a rake, and a broom.

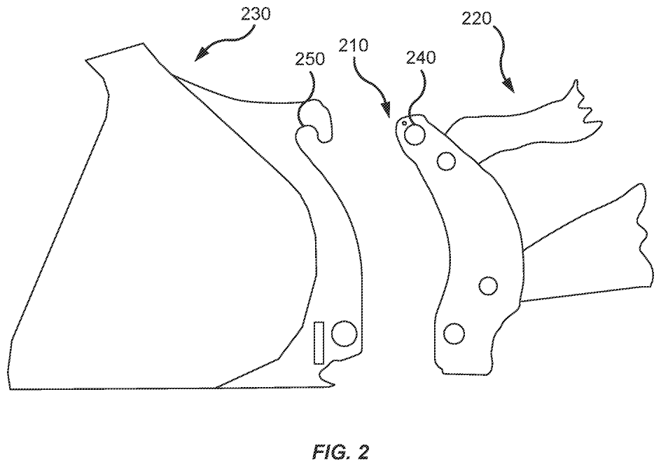

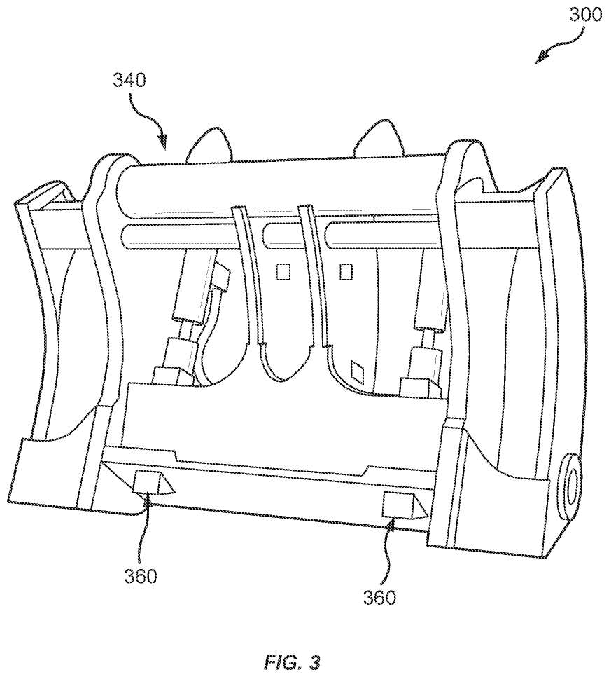

Referring to FIG. 2, a coupler 210 can be attached to a free end of the boom (or lifting linkage) 220. Various attachments 230 may be connected quickly and securely to the machine 100 via the coupler 210 without an operator or other worker needed to make the connection manually. The coupler 210 may include at least one retention pin, or wedge (see FIG. 3). In one or more aspects, the coupler 210 may have a bar 240 disposed near a top of the coupler 210 and extending in a direction that is substantially transverse to a plane of motion of the boom 220. The attachment 230 may have one or more hook-shaped pieces 250 that open downward. When connecting to the attachment 230, the operator moves the coupler 210 toward the attachment 230 with the bar 240 of the coupler facing toward the attachment 230. The bar 240 may be positioned under the hook-shaped pieces 250 and moved upward so that the bar 240 is caught by the one or more hook-shaped pieces 250. The coupler 210 may be rotated (e.g., via the boom 220) to bring the bar 240 up and lifted so that the attachment 230 is suspended free of the ground. At this point, each retention pin should be aligned with a corresponding opening in the attachment.

FIG. 3 provides a perspective view of a coupler 300. The coupler 300 includes a bar 340 that is used in connecting to an attachment as described above in connection to FIG. 2. The coupler 300 also includes a pair of retention pins 360 that engage an attachment through corresponding openings in the attachment, thus securely connecting the attachment to the coupler 300 and the rest of the machine.

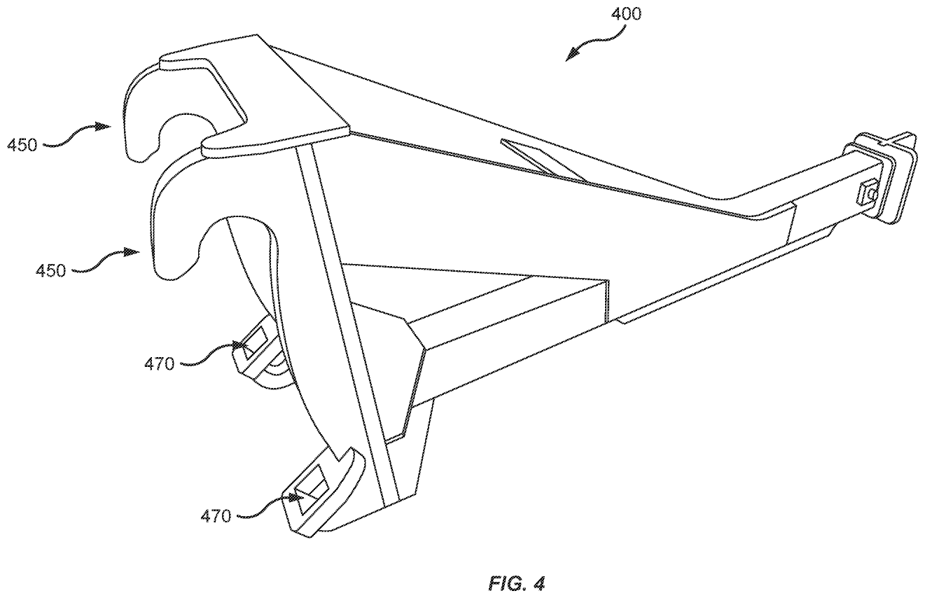

A material handling arm (or jib) 400, another type of attachment, is depicted in FIG. 4. In the orientation depicted, a machine with a coupler would approach the material handling jib 400 from the left, positioning a bar 240, 340 under the pair of hook-shaped pieces 450. A secure connection may be completed by inserting a retention pin 360 of the coupler into a corresponding opening 470 in the material handling jib 400. As depicted in FIG. 4, a pair of retention pins 360 may be inserted, but the number of retention pins and corresponding openings 470 may be more or less, depending on the requirements of the situation.

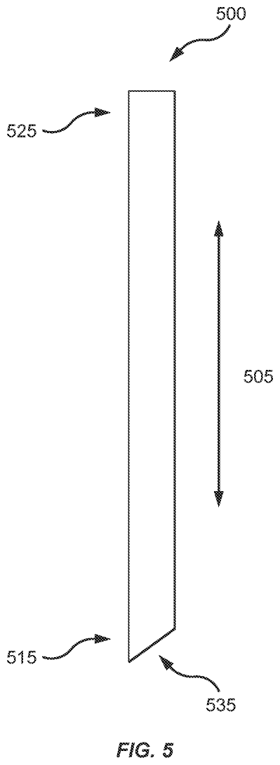

As presented in FIG. 5, a retention pin 500 may be elongated, the elongate direction 505 extending from a first end 515 to a second end 525. The first end 515 may include a wedge shape 535 to more easily allow the first end 515 of the retention pin 500 to be inserted in the corresponding opening in the attachment. The first end 515 may be oriented generally downward so that in a passive state, the retention pin will stay in the opening of the attachment, keeping the attachment securely connected to the machine via the coupler. At least one retention pin is provided in a coupler. The retention pin 500, as described herein with respect to FIG. 5, is for the purposes of illustration. In some examples, a retention pin may be in other shapes, depending on the requirements for coupling to the attachment. For example, the retention pin may be shaped more like a wedge, being wider in a direction transverse to the elongate direction 505 of the retention pin 500 shown in FIG. 5.

Some machines may use retention pins or wedges at both the bottom and the top of the coupler. For example, an excavator may need to change bucket sizes or change to other work tool attachments. In such cases, a retention pin or wedge may be utilized to ensure that the attachment does not separate from the coupler at the top where hook-shaped pieces from the attachment hang on and over the bar at the top of the coupler.

Retention pins may be extended and retracted from a coupler by various means. Hydraulic systems may be used to perform these functions. One or more springs, operating under either tension or compression may be used to move a retention pin. Springs may be well suited for positioning a retention pin in a default state because springs require no external energy source to operate. For reasons of safety, the default state of a retention pin may be extended from the coupler and inserted into a corresponding opening in the attachment, if present. For example, the retention pin may be inserted in the opening in the attachment when the electric temperature-altering device is not active.

Another means of extending and/or retracting a retention pin includes a thermoactuator (also known as a thermal actuator). A thermoactuator uses changes in temperature to generate a force for moving an object. For example, an increase in temperature of at least a portion of the thermoactuator may cause an enclosed volume of material to expand, applying a force to a piston that moves a rod. The expansion may be a volumetric expansion of a single phase (for example, liquid) of the enclosed material. In other cases, adding thermal energy to increase the temperature of the enclosed material may produce a phase change (for example, from solid to liquid) that produces an increase in volume of the enclosed material and a displacement of the piston. In the present disclosure, a thermoactuator may directly or indirectly extend or retract a retention pin.

Removal of heat (cooling), for example with a cold plate or sleeve, may also be used in a thermoactuator. Flowing a coolant, either liquid or gas, over or through all or part of a thermoactuator may also be used for cooling. Cooling typically produces a decrease in volume, thus a piston may be retracted to create a pulling force. Some materials may actually increase in volume with decreasing temperature over a particular temperature range.

Thus, heating and cooling may be used in a complementary manner in a thermoactuator. In one or more embodiments, the thermoactuator may include a spring to restore the piston to a deactivated position.

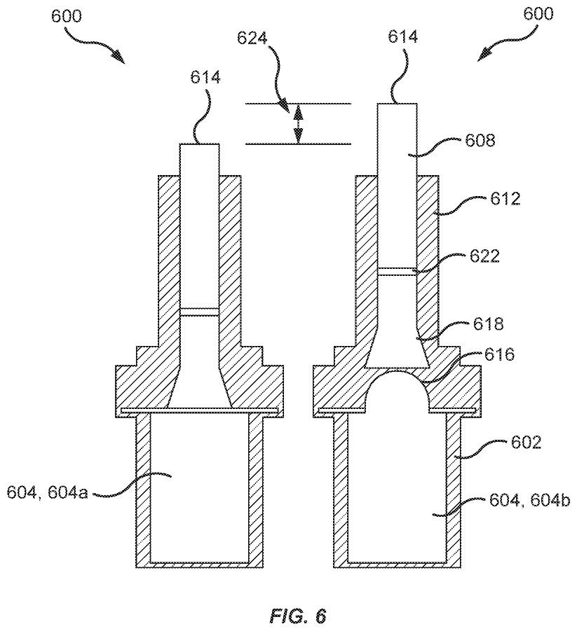

Referring to FIG. 6, a wax motor 600 may include a chamber 602. The chamber 602 may be cylindrical, although other shapes are possible. The chamber 602 may be filled with a material 604. The material 604 is enclosed in the chamber 602 by a piston 608 disposed at one end of the chamber 602. The volume of the material 604 may change as a function of temperature. For example, the volume of the material 604 may increase with increasing temperature, or in some cases, the volume may decrease with increasing temperature. For the remainder of the present disclosure the discussion will focus on increasing volume with increasing temperature.

A change in volume may occur while the material 604 remains in a single phase of matter, in a liquid state for example. A greater change in volume may be produced with the addition of an equal amount of heat when the material 604 undergoes a change in phase, such as from solid to liquid.

Referring again to FIG. 6, when the material is cold 604a on left, the volume occupied in the wax motor 600 is less than the volume occupied when hot 604b. As a result, the material 604, either directly or indirectly exerts a force on the piston 608, moving the piston 608 through a guide 612, causing the piston 608 to be displaced and exert a force on a load 614. Between the material 604 and the piston 608, there may be a diaphragm 616, a plug 618, an anti-chafing disk 622, and/or other similar components to tailor the operation and cost of the wax motor as desired. The diaphragm 616 can seal in the material 604 and be displaced as the volume of the material changes. The plug 618 can transmit and amplify the linear motion of the piston 608 as the material changes volume. The anti-chafing disk 622 may prevent the plug 618 from extruding around the piston 608 when a compressive force is applied. The displacement, or stroke, 624 of the wax motor is the change in position of the piston (or a fixed point on the piston) from the low temperature state (for example, solid) to the high temperature state (for example, liquid).

The material 604 may be a wax. The wax may be comprised of hydrocarbons, including a blend of hydrocarbons. The wax may comprise paraffin waxes (e.g., straight-chain n-alkane series). The wax may be synthetic, vegetable, or other materials suitable for the intended purpose. The material 604 may be chosen so that relatively small addition of heat will produce a phase change. Advantageously, wax can have a very low compressibility so that volumetric expansion of the wax in a confined space does not result in a significant loss in displacement or force. In one or more aspects, the material 604 may include a wax that increases in volume as a function of increasing temperature. In another aspect, the wax may undergo a phase change from solid to liquid with increasing temperature that produces a majority of the increase in volume.

In one or more aspects of the disclosure, a thermoactuator may replace a hydraulic cylinder for moving a retention pin on a coupler while connecting to or disconnecting from an attachment.

A thermoactuator may include a wax motor that uses wax as the enclosed material. The wax may be a hydrocarbon such as paraffin waxes (e.g., the straight-chain n-alkane series), vegetable-based wax, synthetic wax, as well as others.

Heating the material in the chamber of a wax motor may be achieved in a variety of ways. An electrical heater may be used. The electrical heater could be a heating coil wrapped around the chamber or the wax motor. Alternatively, one or more thermistors could be used. For example, a positive temperature coefficient (PTC) thermistor may be used to provide heat and an increase in temperature of the material in the chamber as a function of current passing through the PTC thermistor.

If the machine produces excess heat, for example as a byproduct of an internal combustion engine, some of the excess heat may be diverted to a thermoactuator as needed to change the state of the material in the chamber of the wax motor.

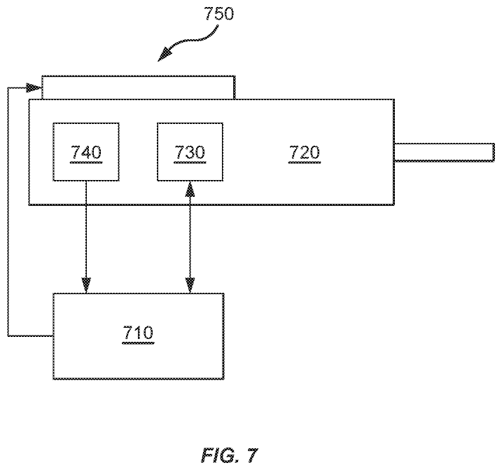

Referring now to FIG. 7, a controller 710 may be used to manage a thermoactuator 720. The controller 710 may include one or more memories and one or more processors that are configured to perform the following steps. The controller 710 may include outputting a signal to increase the temperature of the material in the wax motor chamber by providing additional current to an electrical heater 730 or increasing fluid flow from a heat source such as an ICE.

The controller 710 may receive input from a sensor 740 that measures a temperature that is monotonically related to a temperature of the material. The temperature sensor 740 may be a thermocouple, a resistive thermal device (RTD), and the like. If the heater 730 is calibrated, the controller 710 may monitor the current and/or voltage applied to the heater 730 to determine the temperature of the heater 730, and thus, have a proxy for the temperature of the material in the chamber. The controller 710 may maintain the temperature of the material at a first predetermined temperature when the retention pin is inserted in the opening in the attachment and/or a second predetermined temperature when the retention pin is not inserted in the opening in the attachment.

The controller 710 may adjust the temperature of the material to allow change from the one state of the material to a second state (for example, liquid to solid).

The thermoactuator 720 may also include a cooler 750, that is, a means of cooling the material when, for example, the heater 730 is off. The cooler 750 may be a cold plate, a cooling fluid (liquid or gas) flowing over the chamber, a heat sink, and the like. The controller 710 may control the heater 730 and/or the cooler 750 to maintain the appropriate temperature for the operation of the wax motor.

Wax motors may also include a spring, under either tension or compression, to supply a restoring force to the piston when the wax motor is not activated.

The piston of a thermoactuator may mechanically connect directly or indirectly to a corresponding retention pin of a coupler. With a direct connection, the direction of movement of the piston and the direction of movement of the retention pin would be substantially the same. In other words, if the retention pin is elongate and moves in the elongate direction, the retention pin and the piston lie along substantially parallel or substantially collinear lines.

The piston may mechanically connect indirectly to a corresponding retention pin through one or more levers and/or a plurality of gears. Levers and gears may be used to alter the direction and/or the amplitude of the applied force and the displacement. Using ratios of lever arms and/or gearing ratios, the displacement of the retention pin may be amplified from the displacement of the piston with a concomitant reduction in force.

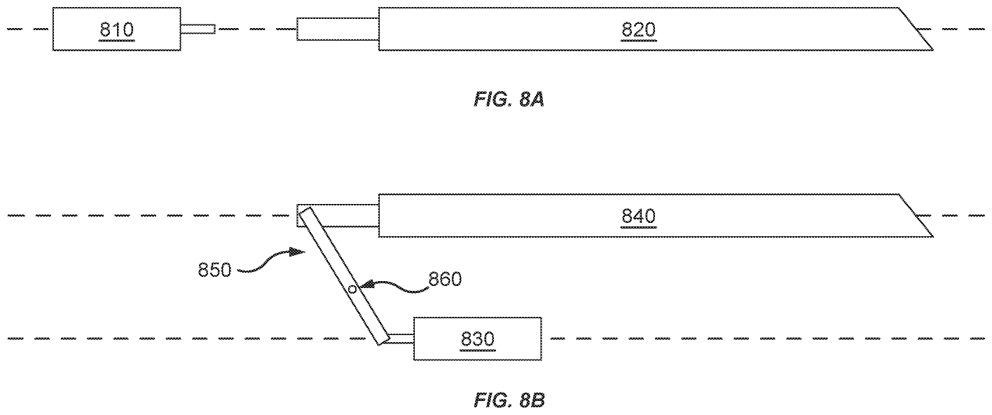

Referring to FIG. 8A, both thermoactuator 810 and retention pin 820 are in the plane of the page and are thus coplanar. Further the thermoactuator 810 and the retention pin 820 are collinear. Although not shown in FIG. 8A, the thermoactuator and the retention pin may be mechanically connected indirectly by one or more rods, levers, and/or gears or directly. Example fasteners may include pins, nuts, bolts, and the like.

In FIG. 8B, both the thermoactuator 830 and retention pin 840 are in the plane of the page, and thus coplanar. However, they are not collinear. In FIG. 8B, the thermoactuator and the retention pin are parallel (which is understood herein to include antiparallel as well). The thermoactuator 830 and the retention pin 840 are mechanically connected by a simple lever 850 with a fulcrum or pivot 860. As discussed elsewhere, levers and gears may be included to amplify displacement and reduce force or vice versa as well as for space and layout considerations.

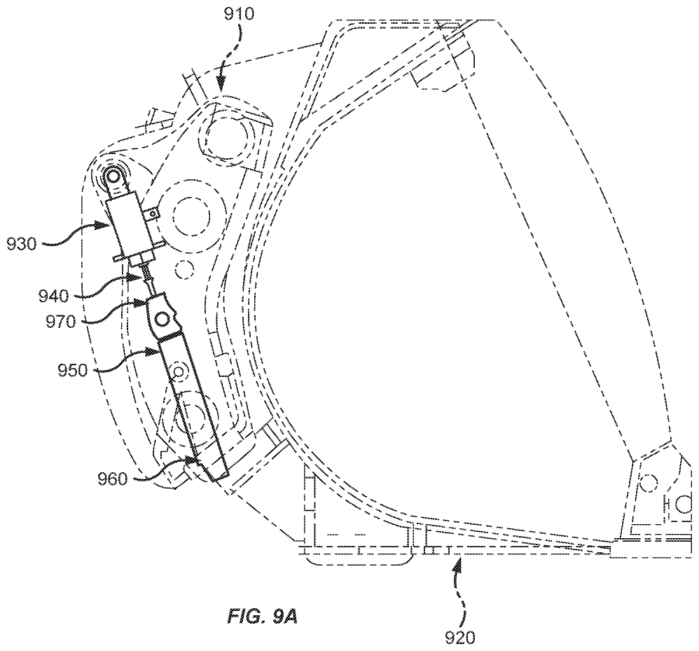

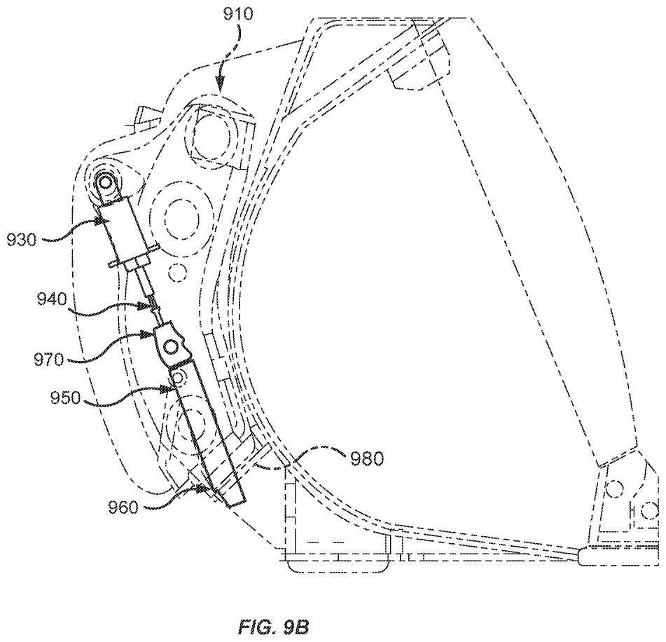

FIGS. 9A-11B present some ways in which a thermoactuator may be used in a coupler. FIG. 9A shows a coupler 910 and an attachment 920, which in this case is a bucket. The coupler 910 includes a thermoactuator 930 that includes a piston 940. The end of the thermoactuator 930 opposite the piston 940 is secured to the coupler 910. A retention pin 950 is oriented generally parallel to the thermoactuator 930. The retention pin 950 has a first end 960 disposed adjacent to an opening in the attachment 920 into which the first end 960 is inserted when the attachment 920 is locked and secured to the coupler 910. Opposite the first end 960 is a second end 970 of the retention pin 950. The second end 970 is mechanically connected to the piston 940. While the connection in this example is direct, a connection may also be indirect and include one or more levers, rods, gears, and the like. In FIG. 9A, the thermoactuator 930 (assuming that actuation extends the piston 940 from the body of the thermoactuator 930) is not activated, the piston 940 is not extended, the retention pin 950 is not inserted into the corresponding opening in the attachment 920. Thus, the attachment 920 is not locked or securely connected to the coupler 910.

FIG. 9B presents the apparatus of FIG. 9A, but with the thermoactuator 930 activated. The activation results in the piston 940 extending in the direction of the retention pin 950. The retention pin, which is slidably connected to the coupler 910, moves under the force of the piston 940 to insert the first end 960 into a corresponding opening 980 (seen from side) in the attachment 920, thus securing the attachment 920 to the coupler 910.

While the mode of operation depicted in FIGS. 9A and 9B are workable, other modes that passively lock the attachment 920 to the coupler 910 have the advantage of securing the attachment to the coupler even when no power is supplied to the thermoactuator.

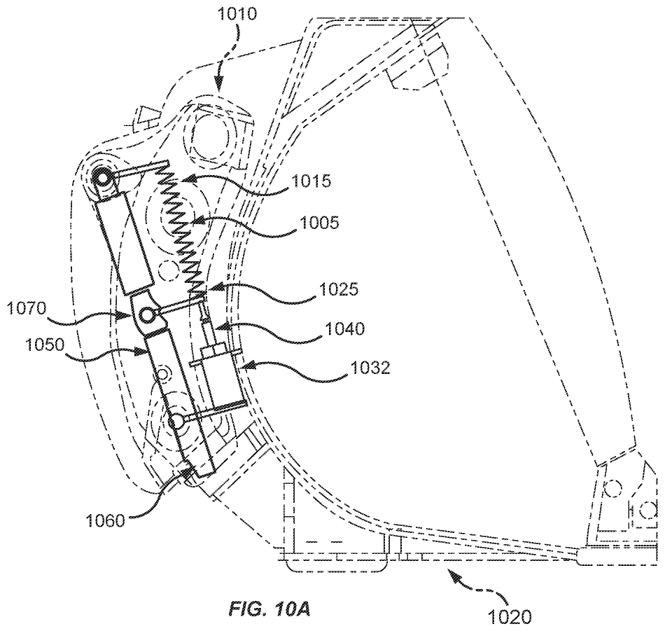

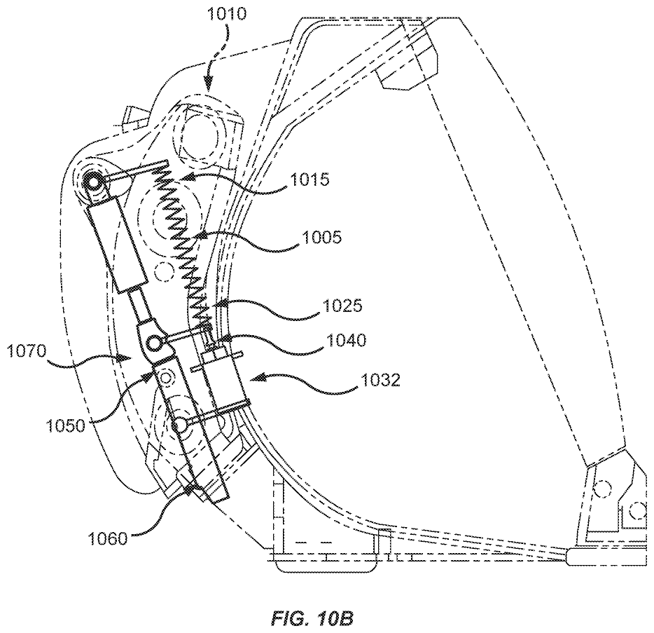

A second example is presented in FIGS. 10A and 10B. Much of the description is the same as previously presented and will not be repeated here. Referring to FIG. 10A, a spring 1005 is attached at a first end 1015 to the coupler 1010 and at a second end 1025 to the first end 1060 of the retention pin 1050 and to the piston 1040. The end of the thermoactuator 1032 opposite the piston 1040 is attached to the coupler.

In this example, the spring 1005 is under compression. Thus, when the thermoactuator 1032 is activated and the piston 1040 is extended, compressing the spring 1005, the retention pin 1050 is retracted from the corresponding opening in the attachment 1020.

In FIG. 10B, the thermoactuator 1032 is not activated, the piston 1040 is retracted into the body of the thermoactuator, and the force of the spring 1005 passively forces the retention pin 1050 into the opening of the attachment 1020, securing the attachment to the coupler 1010. That is, the spring 1005 may be disposed on the coupler 1010, mechanically connected to the retention pin 1050, and configured to apply a second force (the first force being exerted by, say, the piston) on the retention pin 1050 capable of displacing the retention pin 1050 into the opening in the attachment 1020.

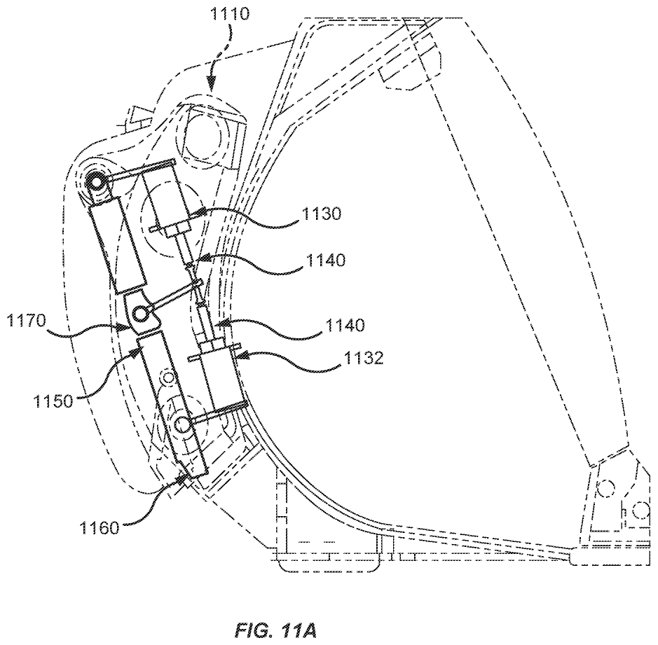

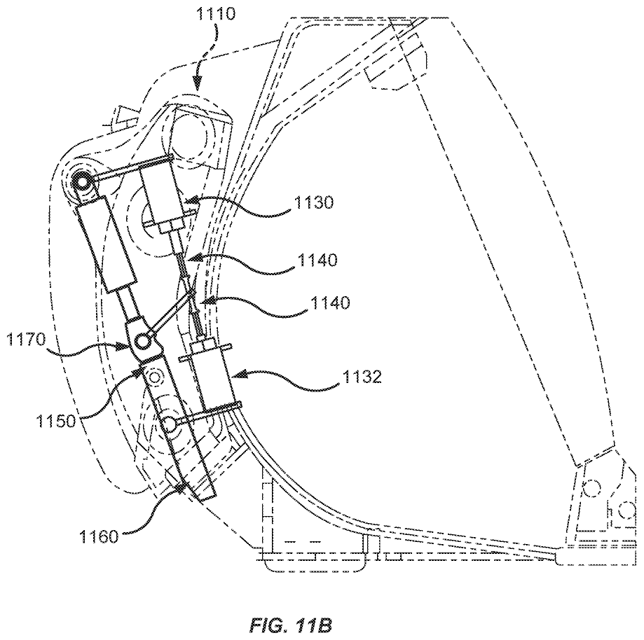

FIGS. 11A and 11B present a third aspect of the present disclosure. In this example, respective pistons 1140 of two opposing thermoactuators 1130, 1132 of coupler 1110 are connected together and to a first end 1170 of the retention pin 1150. In this example when one thermoactuator 1130 is activated, the second thermoactuator 1132 is not activated. Thus, this combination of pushing and pulling allows the retention pin 1150 to be moved under force to either be inserted into the corresponding opening in the attachment or retracted from the corresponding opening. That is, the second thermoactuator 1132 may be disposed on the coupler and configured, when activated, to exert a third force on the retention pin 1150 that is opposed to the first force, for example, a force exerted by the one thermoactuator 1130.

### INDUSTRIAL APPLICABILITY

The industrial applicability of the systems, devices, and methods described herein will be readily appreciated from the foregoing discussion. The foregoing discussion is applicable to a device for securing an attachment to a coupler, a coupler with the device, and a machine that includes the coupler for at least construction sites, demolition sites, infrastructure construction and repair sites, warehouses, mining sites, transportation depots and ports, and the like. Wheel loaders and the like may be equipped with a quick coupler device that allows changing the work tool (bucket, forks, etc.) without an operator needing to leave the cab of a machine in order to remove and/or attach tools. A wax motor may be included in a thermoactuator to provide sufficient force and displacement to move a retention pin in a coupler for a wheel loader or other machine. In particular, a wax motor may reduce cost by avoiding an additional hydraulic circuit on a fundamentally electric machine.

It will be appreciated that the foregoing description provides examples of the disclosed device, coupler, and machine. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by this disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A device for securing an attachment to a coupler, the device comprising:
a retention pin defining an elongate direction and configured to be disposed on the coupler,
wherein, to secure the coupler to the attachment, the retention pin is configured to move in the elongate direction to insert a first end, of the retention pin, into an opening in the attachment; and
a thermoactuator including:
a chamber associated with the coupler and containing a material that changes volume as a function of temperature,
wherein an end of the chamber is sealed with a piston that is mechanically connected to the retention pin proximate to a second end of the retention pin, the second end being disposed opposite the first end; and
an electric temperature-altering device that, when activated, changes the temperature and volume of the material causing the piston to exert a first force on the retention pin that moves the retention pin relative to the opening in the attachment.

2. The device of claim 1, wherein the piston is mechanically connected to the retention pin via one or more levers and/or a plurality of gears.

3. The device of claim 1, wherein the attachment comprises a work tool that includes at least one member of a group consisting of a plow, a spreader, forks, a material handling arm, a grapple, a high dump, a bucket, a rake, and a broom.

4. The device of claim 1, wherein:
the thermoactuator comprises a wax motor,
the electric temperature-altering device comprises a heater, and
the material comprises a wax that increases in volume as a function of increasing temperature.

5. The device of claim 4, wherein the wax undergoes a phase change from solid to liquid with increasing temperature that produces a majority of the increase in volume.

6. The device of claim 4, further comprising a means of cooling the material when the heater is off.

7. The device of claim 1 further comprising a temperature sensor configured to measure a temperature that is monotonically related to the temperature of the material.

8. The device of claim 7 further comprising a controller that maintains the temperature of the material at a first predetermined temperature when the retention pin is inserted in the opening in the attachment and/or a second predetermined temperature when the retention pin is not inserted in the opening in the attachment.

9. The device of claim 1, wherein the retention pin is inserted in the opening in the attachment when the electric temperature-altering device is not active.

10. The device of claim 1, wherein the piston and the retention pin are substantially coplanar.

11. The device of claim 10, wherein the piston and the retention pin lie along substantially parallel or substantially collinear lines.

12. The device of claim 1 further comprising a spring disposed on the coupler, mechanically connected to the retention pin, and configured to apply a second force on the retention pin capable of displacing the retention pin into the opening in the attachment.

13. The device of claim 1 further comprising a second thermoactuator disposed on the coupler and configured, when activated, to exert a third force on the retention pin that is opposed to the first force.

14. A coupler configured to be disposed on a machine and to securely connect an attachment to the machine, the coupler comprising a device for securing the attachment to the coupler, the device comprising:
a retention pin comprising an elongate direction and configured to be disposed on the coupler and to move in the elongate direction to insert a first end in the elongate direction into an opening in the attachment, securing the coupler to the attachment;
a thermoactuator comprising:
a chamber configured to be fastened to the coupler, containing a material comprising a volume that changes as a function of temperature, and sealed at an end with a piston that is mechanically connected to the retention pin proximate to a second end of the retention pin, the second end being disposed opposite the first end; and
an electric temperature-altering device that, while activated, changes the temperature and volume of the material causing the piston to exert a first force on the retention pin that moves the retention pin relative to the opening in the attachment.

15. The coupler of claim 14, wherein:
the thermoactuator comprises a wax motor,
the electric temperature-altering device comprises a heater, and
the material comprises a wax that increases in volume as a function of increasing temperature.

16. The coupler of claim 15, wherein the wax undergoes a phase change from solid to liquid with increasing temperature that produces a majority of the increase in volume.

17. The coupler of claim 14, wherein the device further comprises a temperature sensor configured to measure a temperature that is monotonically related to a temperature of the material.

18. The coupler of claim 17, wherein the device further comprises a controller that maintains the temperature of the material at a first predetermined temperature when the retention pin is inserted in the opening in the attachment and/or a second predetermined temperature when the retention pin is not inserted in the opening in the attachment.

19. A machine comprising:
a means of moving;
a coupler configured to be disposed on the machine and including a device to securely connect an attachment to the machine via the coupler, the device including:
a retention pin defining an elongate direction and configured to be disposed on the coupler, wherein to secure the coupler to the attachment, the retention pin is configured to move in the elongate direction to insert a first end of the retention pin into an opening in the attachment; and
a thermoactuator including:
a chamber configured to be fastened to the coupler, containing a material comprising a volume that changes as a function of temperature, and sealed at an end with a piston that is mechanically connected to the retention pin proximate to a second end of the retention pin, the second end being disposed opposite the first end; and
an electric temperature-altering device that, while activated, changes the temperature and volume of the material causing the piston to exert a first force on the retention pin that moves the retention pin relative to the opening in the attachment.

20. The machine of claim 19, wherein:
the thermoactuator comprises a wax motor,
the electric temperature-altering device comprises a heater, and
the material comprises a wax that increases in volume as a function of increasing temperature.
